(19) United States
(12) Patent Application Publication
(10) Pub. No.: US 2012/0304619 A1
(43) Pub. Date: Dec. 6, 2012

(54) ENGINE FOR THRUST OR SHAFT OUTPUT AND CORRESPONDING OPERATING METHOD

(76) Inventor: Michael Alan Beachy Head, Newlands (ZA)

(21) Appl. No.: 13/579,448

(22) PCT Filed: Nov. 19, 2010
(86) PCT No.: PCT/IB10/55302

§ 371 Date: Aug. 16, 2012

(30) Foreign Application Priority Data
Feb. 16, 2010 (GB) 1002642.5

(51) Int. Cl. F02K 3/06

(52) U.S. Cl. 60/204; 60/226.1

(57) ABSTRACT

An engine and a method of operating the engine are provided. The engine includes a gas turbine and fan that rotate together to provide an exhaust gas flow stream, which flows over a free turbine that is connected to a power take-off. The free turbine can extract energy from the exhaust gas flow stream and transfer it as shaft power to the power take-off and the amount of energy extracted by the free turbine is controlled by varying the pitch of the free turbine's blades and/or by varying the pitch or stator vanes of a stator upstream of the free turbine. The control over the amount of energy extracted by the free turbine allows the engine to be used to provide thrust from the gas turbine and fan or to provide shaft power at the power take-off, or a combination of thrust and shaft power.

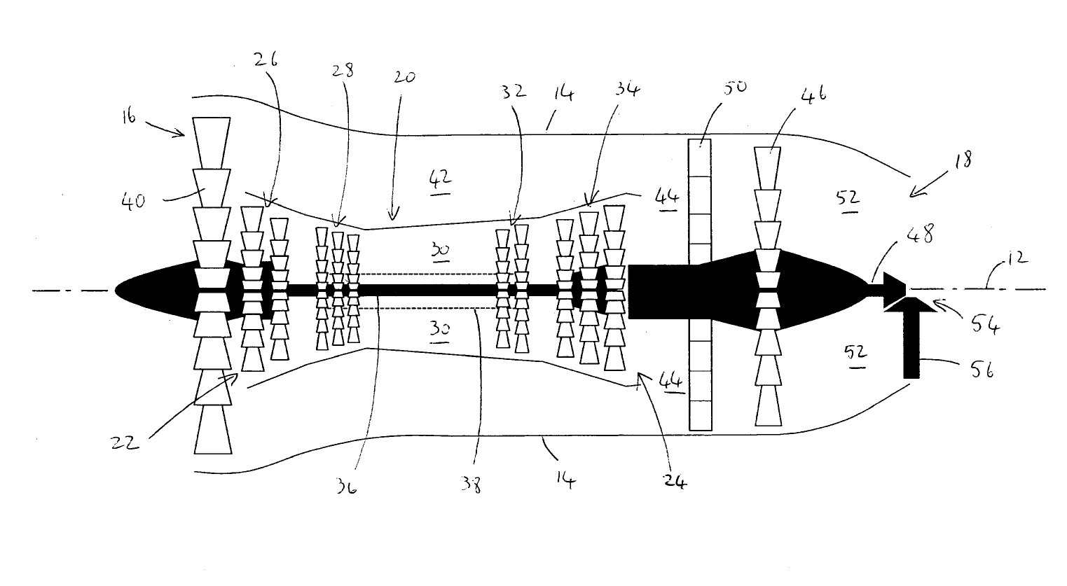

### CROSS REFERENCE TO RELATED APPLICATIONS

This application is a U.S. national phase of co-pending international patent application No. PCT/IB2010/055302, filed Nov. 19, 2010, which claims priority to Great Britain application No. GB1002642.5, filed Feb. 16, 2010, the disclosures of which are incorporated herein by reference.

### FIELD OF THE INVENTION

This invention relates to engines that can provide thrust or shaft output or both at any ratio and that thus allows the engine to be used in composite aircraft, although the scope of the invention is not limited to aircraft engines. In particular, the invention relates to an engine and a method of operating an engine.

### BACKGROUND TO THE INVENTION

In some applications, shaft power is required in some modes of operation, while thrust power is required in other modes of operation. This is the case in some composite aircraft where shaft power is required to drive rotary wings and provide lift during takeoff, hovering and/or landing, while thrust is required for propulsion during forward flight. In some applications, a split or combination of these power outputs may be required, or a smooth transition between them.

The use of separate engines to provide thrust and shaft output holds the disadvantage of the excess weight of the two engines and it is desirable to use a single engine to provide thrust and shaft output in the most efficient manner.

Some engines and/or propulsion systems have been developed where a flow of high energy gas is generated (e.g. in a gas turbine) and exhaust gasses from the generator are used to drive one or both of two propulsion systems, by diverting the exhaust gasses to different flow passages, but these engines were inefficient due to energy losses associated with changing the flow direction of the exhaust gasses and the engines were cumbersome and heavy due to the use of additional gas passages.

A composite engine is disclosed in U.S. Pat. No. 3,678,690 that includes a gas generator and two coaxial free turbines propelled by gas from the generator—the free turbines being connected to a bypass fan (for thrust) and a power take-off, respectively. Vanes are provided upstream of each of the free turbines and can be pivoted to throttle/divert the inlet passages to each of the free turbines, to direct gases from the generator to either or both the free turbines. This engine is inefficient due to energy losses associated with diverting the gases and it has the disadvantages of the extra weight and bulk of additional gas passages. The engine also has the undesirable complexity of having to develop an engine specifically for the purpose or having to modify an existing “off-the-shelf” engine quite substantially.

A convertible engine is disclosed in U.S. Pat. No. 4,651,521 that includes a gas generator and a single free turbine propelled by gas from the generator. The free turbine is connected via a bevel gear set to a power take-off and via a torque converter to a bypass fan. When only shaft power is required, power transfer to the fan through the torque converter is prevented and as more thrust power is required, power transfer through the torque converter is enabled. When only thrust power is required and no shaft power, the power take-off shaft is disengaged. This engine has the disadvantages of a relatively complex design and the engine needs to be purpose designed and build almost entirely with its unique mechanism and it thus offers no possibility of using a proven off-the-shelf engine.

U.S. patent applications Ser. Nos. 11/998,291 and 11/998,248 (published as U.S. 2009/0139202 and U.S. 2009/0140182, respectively) disclose a convertible gas turbine propulsion system that includes a gas generator and two free turbines driven in series by exhaust gas from the generator to provide power to primary and secondary propulsion systems, respectively. An adjustable port is provided between the free turbines, which allows gas exhausted from the first free turbine to be discharged selectively to atmosphere. This system does not allow power to the primary propulsion system to be cut or to be used to drive the secondary propulsion system in isolation. It also does not provide means for using generated exhaust gases directly as thrust for forward motion.

The present invention seeks to provide an engine that can be used to provide thrust, shaft power output or both thrust and shaft power output in an efficient and cost effective manner, without undue weight, size or complexity.

### SUMMARY OF THE INVENTION

According to one aspect of the present invention there is provided an engine comprising:
a gas turbine having an axis, an intake end and a discharge end, said gas turbine comprising at least a single stage compressor at the intake of the gas turbine, at least a single stage turbine at the discharge of the gas turbine, said turbine being rotationally connected to the compressor of the gas turbine, to rotate about the axis, and said gas turbine defining a combustion chamber between its compressor and its turbine;
at least one fan that is rotatable coaxially with the gas turbine and that is rotationally connectable to at least one turbine of the gas turbine;
a casing defining a discharge flow passage leading from the discharge end of the gas turbine; and
at least one free turbine, rotationally supported in the discharge flow passage and connectable to a power take-off, said free turbine being configured to extract power from a gas stream flowing in the discharge flow passage, to convert said power to shaft power and to transfer said shaft power to the power take-off;
characterised in that said free turbine is configured to control the amount of energy it extracts from said gas stream in the discharge flow passage.

The blades of the free turbine may be configured to pivot to vary their pitch.

In this specification, the term “pitch” refers to the “blade pitch” or “blade pitch angle”, which is the angle of the blade relative to the turbine's axis. If the gas flow direction is perfectly axial, the “pitch” would thus be the same as the “angle of attack” of the blade and for the sake of simplicity of explanation, this can be assumed to be the case in the description below. Gasses in engines embodying the present invention may swirl and in such cases, the pitch of the turbine blades relative to the turbine axis would not be the same as the angle of attack of the blades, but the distinction is not important for the principles underlying this invention.

The engine may include a stator disposed in the discharge flow passage, between the discharge end of the gas turbine and the free turbine and the stator vanes of the stator may have an axial orientation relative to the free turbine or the stator vanes may pivot to vary their pitch

The casing may extend around the fan and the fan may be disposed at the intake of the gas turbine so that a bypass flow passage is defined by the casing, which extends from the fan to the discharge end of the gas turbine, the bypass flow passage being continuous with the discharge flow passage.

The profiles of the free turbine's blades may be symmetrical about their chord lines and/or the profiles of the stator vanes of may be symmetrical about their chord lines.

According to another aspect of the present invention there is provided a method of operating an engine, said method comprising:
running a gas turbine to generate an exhaust gas flow stream emanating from a discharge end of the gas turbine;
driving a fan with rotational power from the gas turbine;
passing the exhaust gas flow stream over a free turbine; and
extracting power from the exhaust gas flow stream in the free turbine;
converting said power to shaft power; and
transferring said shaft power from the free turbine via a power take-off;
wherein said method further comprises controlling the amount of energy extracted by the free turbine from the exhaust gas stream.

The amount of energy extracted from the exhaust gas stream by the free turbine may be controlled by varying the pitch of the free turbine's blades. Alternatively, or in addition, the method may include passing the exhaust gas flow stream over a stator before passing it over the free turbine and the amount of energy extracted from the exhaust gas stream by the free turbine may be controlled by varying the pitch of the stator's vanes.

The method may further comprise generating a bypass flow stream of air from the fan and passing the bypass flow stream over the free turbine. The exhaust gas flow stream and the bypass flow stream may be combined before passing them over the free turbine.

The method may include varying the pitch of the free turbine's blades and/or varying the pitch of the stator's vanes until they are feathered and the gas flow generated by the gas turbine and the fan may be used to provide thrust to propel an aircraft.

The term “feathered” refers to adjustment of the blade until it has a zero angle of attack. As mentioned above, for practical purposes, this can be assumed to the case if the blades have zero pitch, i.e. an axial orientation, but if there is swirl in the gas flow stream, the turbine blades would, strictly speaking be “feathered” when they have a small, non-zero pitch.

The method may include transferring rotational power from the free turbine via the power take-off to at least one rotor to provide lift for an aircraft.

### BRIEF DESCRIPTION OF THE DRAWING

For a better understanding of the present invention, and to show how the same may be carried into effect, the invention will now be described by way of non-limiting example, with reference to the accompanying drawing which shows a schematic diagram of an engine in accordance with the present invention.

### DETAILED DESCRIPTION OF THE DRAWING

Referring to the drawing, an engine in accordance with the present invention is generally indicated by reference numeral 10.

The engine 10 can be used in many other applications, but is particularly intended for use in hybrid aircraft that use a rotor for lift to take off, land and hover and that uses jet thrust to propel it during forward flight. The engine 10 is required to provide rotational or shaft power to the rotor at times, to provide jet thrust at times and to provide combinations of these two outputs at times, e.g. during a transition between different operational modes of the aircraft.

The components of the engine 10 are coaxially arranged around an axis 12 and are housed in an outer casing or fairing 14 with an inlet opening 16 and a discharge nozzle 18.

Inside the fairing 14, the engine 10 includes a gas turbine 20 that also has an inlet opening 22 and a discharge opening 24. Immediately inside the inlet opening 22, the gas turbine 20 has a low pressure compressor 26 and aft of the low pressure compressor, in a series arrangement, is a high pressure compressor 28. In the drawing, the gas turbine 20 has a two-stage low pressure compressor 26 and a three stage high pressure compressor 28 that rotates at higher speed, although the gas turbine could have any number of compressors and stages. Aft of the compressors 26,28 an annular combustion chamber 30 is defined inside the gas turbine 20. Immediately aft of the combustion chamber 30, the gas turbine 20 includes a high pressure turbine 32, followed in series by a low pressure turbine 34. The high pressure turbine 32 is shown in the drawing as a two stage turbine and the low pressure turbine 34 as a three stage turbine, but the gas turbine could include any number of such turbines and stages.

The combustion chamber 30 in the illustrated example is annular in shape, but like other illustrated features of the example, the invention is not limited to annular combustion chambers and the combustion chamber could be a “can” or “cannular” combustion chamber, or the like.

The low pressure turbine 34 is connected via a central low pressure shaft 36 to the low pressure compressor 26, to rotate together and as gasses expand in the combustion chamber 30 and pass over the low pressure turbine, it drives the turbine, which drives the low pressure compressor 26 via the shaft 36 so that the compressor can continue to compress air from the intake 16 and pass it into the combustion chamber. Similarly, the high pressure turbine 32 is driven by the expansion of gasses in the combustion chamber 30 and rotation of the high pressure turbine 32 is transferred via a hollow high pressure shaft 38 to the high pressure compressor 28. In normal operating conditions, the high pressure shaft 38 rotates substantially faster than the low pressure shaft 36.

Operation of the gas turbine 20 causes a flow of exhaust gasses from the discharge 24, rearwards to the discharge nozzle 18.

Immediately to the front of the inlet 22 of the gas turbine 20 and immediately inside the inlet opening 16 of the engine 10, a fan 40 is provided that is fitted on the low pressure shaft 36, so that it is rotated with the low pressure compressor 26 and low pressure turbine 34 during operation of the gas turbine. The fan 40 draws air into the inlet opening 16 and blows part of it towards inlet 22 of the gas turbine 20 and blows some of the air around the gas turbine along an annular bypass passage 42 that is defined around the gas turbine, inside the fairing 14.

Immediately aft of the gas turbine, the fairing 14 extends around a mixing passage 44 where hot exhaust gas from the discharge 24 of the gas turbine 20 is combined with cooler bypass air from the bypass passage 42, to form a mixed gas flow stream inside the fairing. The mixing passage 44 forms the front of a discharge flow passage 52 along which the mixed gas flow stream flows inside the aft part of the fairing 14 to the discharge nozzle 18. As shown in the drawing, the fairing 14 and the various flow passages inside it are complete, with the bypass passage 42 extending parallel to the flow of gasses in the gas turbine 20 and these parallel flow streams combining in the mixing passage 44 and flowing along the discharge flow passage 52 to the discharge nozzle 18.

In a rear part of the engine 10, a free turbine 46 is supported on a free turbine shaft 48 that is connected via a bevel gear set 54 to a power take-off shaft 56 that extends transversely out of the discharge nozzle 18. The free turbine shaft 48 is aligned with the low pressure shaft 36, but these shafts are not connected and can rotate separately without direct interference. The bevel gear set 54 and transverse power take-off shaft 56 form a fully built-in power take-off mechanism for transferring power to an aircraft rotor. However, apart from the power take-off mechanism (54,56) shown in the drawing, rotational shaft power from the shaft 48 can be transferred to an aircraft rotor via a variety of other transmission systems, suitable for the particular application, e.g. in some applications it may be preferable to transfer shaft power from the free turbine shaft 48 at other angles.

A stator 50 is provided between the mixing passage 44 and the free turbine 46 and has axially oriented stator vanes which straighten or align the flow of gasses, before the gasses impinge on the free turbine.

The pitch of the free turbine 46's blades can be varied by pivoting the blades, so that the extent to which the free turbine extracts energy from the flow stream of mixed gasses, can be varied. Each blade of the free turbine 46 has a cross sectional profile that is symmetrical about its chord line, i.e. it has an airfoil profile with symmetrical “upper” and “lower” surfaces, so that the blades create no lift and cause very little drag when feathered.

The engine 10 can be cost effectively constructed by taking a standard turbofan engine, which includes the gas turbine 20 and fan 40, removing the exhaust duct of the turbofan engine and fitting the remainder of the engine inside the fairing 14, ahead of the power take-off shaft 48 and stator 50.

In use, when substantial rotational power is required from the engine 10, but little or no thrust is required, e.g. when a hybrid aircraft is taking off, hovering or landing with the aid of lift from a rotor powered from the power take-off shaft 56, the blades of the free turbine 46 are pivoted to adjust their pitch to an angle at which the free turbine extracts maximum power from the gas stream in the discharge passage 52 and converts it into shaft power that is transferred to the rotor. In this mode, the free turbine 46's blades will have a relatively large pitch. The gas turbine 20 continues to run and drives the fan 40, both of which contribute to generate the mixed gas flow stream in the discharge passage 52, but the free turbine 46 extracts so much energy from the mixed gas flow stream, that the discharge of gasses out of the discharge nozzle 18 provides little or no significant thrust.

When substantial thrust is required from the engine 10, but little or no shaft power is required, e.g. when a hybrid aircraft is in forward flight mode, the blades of the free turbine are feathered. In this condition, the free turbine 46, like the axially oriented vanes of the stator 50, creates very little impediment to the flow of gasses and the gas turbine 20 and fan 40 can be used in much the same way as a conventional turbofan engine to provide thrust by expelling gasses through the discharge nozzle 18.

When a combination of shaft power and thrust is required, e.g. when rotary wing flight is to be augmented with thrust or during transitions of a hybrid aircraft between rotary wing flight and jet propulsion, the pitch of the free turbine 46's blades can be adjusted so that the free turbine extracts shaft power from the flow of gasses, yet allows sufficient flow of the gasses to provide thrust, in the desired proportions.

In other embodiments of the present invention, the vanes of the stator 50 have a variable pitch. In one such embodiment, the pitch of the free turbine 46's blades is fixed and the pitch of the stator 50's blades can be varied to allow the mixture of gasses to impinge on the free turbine's blades to a greater or a lesser degree and thus to allow more energy from the flow stream of mixed gasses to be extracted by the free turbine and converted to shaft power, or to allow more of the gasses to flow past the free turbine with reduced impedance and provide thrust. In such an embodiment, the free turbine 46's blades could have an axial orientation, i.e. with their chords parallel to the axis 12.

In another embodiment, each of the stator 50's vanes and the free turbine 46's blades have variable pitches, so that their operation can provide a combination of the two embodiments described above, i.e. the pitches are controlled to control the extent to which energy is extracted from the mixed gas flow stream and converted to shaft power by the free turbine and/or the extent to which the gasses are allowed flow past the free turbine with reduced impedance to provide thrust. The ability to vary the pitches on both the stator 50 and free turbine 46 allows the operation of these parts to be optimised to reduce losses.

1. An engine comprising:
a gas turbine having an axis an intake end and a discharge end, said gas turbine comprising at least a single stage compressor at the intake of the gas turbine, at least a single stage turbine at the discharge of the gas turbine, said turbine being rotationally connected to the compressor of the gas turbine, to rotate about the axis, and said gas turbine defining a combustion chamber between its compressor and its turbine;
at least one fan that is rotatable coaxially with the gas turbine;
a casing defining a discharge flow passage leading from the discharge end of the gas turbine; and
at least one free turbine, rotationally supported in the discharge flow passage and connectable to a power take-off, said free turbine being configured to extract power from a gas stream flowing in the discharge flow passage, to convert said power to shaft power and to transfer said shaft power to the power take-off;
characterised in thatwherein said fan is rotationally connectable to at least one turbine of the gas turbine and in that the blades of said free turbine can pivot to vary their pitch to control the amount of energy the free turbine extracts from said gas stream in the discharge flow passage.

2. The engine as claimed in claim 1, wherein the blades of the free turbine can pivot to vary their pitch until they are feathered.

3. The engine as claimed in claim 1 or claim 2, wherein the engine includes a stator disposed in the discharge flow passage, between the discharge end of the gas turbine and the free turbine.

4. The engine as claimed in claim 3, wherein the stator vanes of said stator have an axial orientation relative to the free turbine.

5. The engine as claimed in claim 3, wherein the stator vanes of said stator can pivot to vary their pitch.

6. The engine as claimed in claim 1, wherein the casing extends around the fan.

7. The engine as claimed in claim 6, wherein the fan is disposed at the intake of the gas turbine and a bypass flow passage is defined by the casing, said bypass flow passage extending from the fan to the discharge end of the gas turbine and being continuous with the discharge flow passage.

8. The engine as claimed in claim 1, wherein the profiles of the free turbine's blades are symmetrical about their chord lines.

9. The engine as claimed in claim 3, wherein the profiles of the stator vanes of said stator are symmetrical about their chord lines.

10. A method of operating an engine, said method comprising:
running a gas turbine to generate an exhaust gas flow stream emanating from a discharge end of the gas turbine;
driving a fan;
passing the exhaust gas flow stream over a free turbine;
extracting power from the exhaust gas flow stream in the free turbine;
converting said power to shaft power; and
transferring said shaft power from the free turbine via a power take-off;
characterisedwherein the fan is driven with rotational power directly from a turbine of the gas turbine and characterised by controlling the amount of energy extracted by the free turbine from the exhaust gas stream by varying the pitch of the free turbine's blades.

11. The method as claimed in claim 10, wherein the pitch of the free turbine's blades is adjusted until they are feathered.

12. The method as claimed in claim 10, which includes passing the exhaust gas flow stream over a stator before passing it over the free turbine, and wherein the amount of energy extracted from the exhaust gas stream by the free turbine is controlled by varying the pitch of the stator's vanes.

13. The method as claimed in claim 10, which includes generating a bypass flow stream of air from the fan and passing the bypass flow stream over the free turbine.

14. The method as claimed in claim 13, which includes combining the exhaust gas flow stream and the bypass flow stream, before passing said flow streams over the free turbine.

15. The method as claimed in claim 10, which includes varying the pitch of the stator's vanes until they are feathered

16. The method as claimed in claim 11, which includes using gas flow generated by the gas turbine and the fan to provide thrust to propel an aircraft.

17. The method as claimed in claim 15, which includes using gas flow generated by the gas turbine and the fan to provide thrust to propel an aircraft.

18. The method as claimed in claim 10, which includes transferring rotational power from the free turbine via the power take-off to at least one rotor to provide lift for an aircraft.
